(19) United States
(12) Patent Application Publication
(10) Pub. No.: US 2023/0171802 A1
(43) Pub. Date: Jun. 1, 2023

(54) TERMINAL, AND COMMUNICATION METHOD

(71) Applicant: Panasonic Intellectual Property Corporation of America, Torrance, CA (US)

(72) Inventors: Tomoya NUNOME, Ishikawa (JP); Hidetoshi SUZUKI, Kanagawa (JP); Tetsuya YAMAMOTO, Kanagawa (JP); Akihiko NISHIO, Osaka (JP)

(21) Appl. No.: 17/920,005

(22) PCT Filed: Feb. 18, 2021
(86) PCT No.: PCT/JP2021/006146

§ 371 Date: Oct. 19, 2022

(30) Foreign Application Priority Data
Apr. 24, 2020 (JP) 2020-077694

(51) Int. Cl. H04W 74/08

(52) U.S. Cl. CPC H04W 74/0808

(57) ABSTRACT

This terminal is provided with a control circuit which employs carrier sensing to determine an available resource candidate among a plurality of resource candidates based on units of carrier sensing, and a transmitting circuit which transmits an uplink signal using the available resource candidate.

### TECHNICAL FIELD

The present disclosure relates to a terminal and a communication method.

### BACKGROUND ART

The specification of a physical layer for Release 16 new radio access technology (NR) has been completed as functional extension of the 5th generation mobile communication systems (5G) in the 3rd generation partnership project (3GPP). NR supports functions for realizing ultra reliable and low latency communication (URLLC) in addition to enhanced mobile broadband (eMBB) to meet a requirement such as high speed and large capacity (see, for example, Non Patent Literatures 1 to 5).

### CITATION LIST

### Non Patent Literature

NPL 1
30PP TS 38.211 V16.1.0, “NR; Physical channels and modulation (Release 16)”, March 2020
NPL 2
3GPP TS 38.212 V16.1.0, “NR; Multiplexing and channel coding (Release 16)”, March 2020
NPL 3
3GPP TS 38.213 V16.1.0, “NR; Physical layer procedure for control (Release 16)”, March 2020
NPL 4
3GPP TS 38.214 V16.1.0, “NR; Physical layer procedures for data (Release 16)”, March 2020
NPL 5
3GPP TS 38.331 V16.0.0, “NR; Radio Resource Control (RRC) protocol specification (Release 16)”, March 2020

### SUMMARY OF INVENTION

There is scope for further study, however, on a method of increasing transmission occasions for an uplink signal in an unlicensed band.

One non-limiting and exemplary embodiment facilitates providing a terminal and a communication method each capable of increasing transmission occasions for an uplink signal in an unlicensed band.

A terminal according to an embodiment of the present disclosure includes: control circuitry, which, in operation, determines an available resource candidate by carrier sensing among a plurality of resource candidates that are based on a unit of the carrier sensing; and transmission circuitry, which, in operation, transmits an uplink signal in the available resource candidate.

It should be noted that general or specific embodiments may be implemented as a system, an apparatus, a method, an integrated circuit, a computer program, a storage medium, or any selective combination thereof.

According to an exemplary embodiment of the present disclosure, it is possible to increase transmission occasions for an uplink signal in an unlicensed band.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a block diagram illustrating an exemplary configuration of a part of a terminal;

FIG. 2 is a block diagram illustrating an exemplary configuration of a base station;

FIG. 3 is a block diagram illustrating an exemplary configuration of the terminal;

FIG. 4 is a sequence diagram describing exemplary operations of the base station and the terminal;

FIG. 5 illustrates an exemplary CG parameter configuration according to Configuration Method 1 in Embodiment 1;

FIG. 6A illustrates exemplary transport block generation according to Configuration Method 3 in Embodiment 1;

FIG. 6B illustrates exemplary transport block generation according to Configuration Method 3 in Embodiment 1;

FIG. 7 illustrates exemplary switching of a bandwidth part (BWP) according to Switching Method 1 in Embodiment 2;

FIG. 8A illustrates exemplary switching of a BWP according to Switching Method 2 in Embodiment 2;

FIG. 8B illustrates exemplary switching of a BWP according to Switching Method 2 in Embodiment 2;

FIG. 9A illustrates an exemplary configured grant (CG) resource configuration according to Embodiment 3;

FIG. 9B illustrates an exemplary CG resource configuration according to Embodiment 3;

FIG. 10 illustrates exemplary CG resource configurations according to Embodiment 3;

FIG. 11 illustrates an exemplary architecture for a 3GPP NR system;

FIG. 12 is a schematic diagram illustrating functional split between the next generation-radio access network (NG-RAN) and 5th generation core (5GC);

FIG. 13 is a sequence diagram for radio resource control (RRC) connection setup/reconfiguration procedures;

FIG. 14 is a schematic diagram illustrating usage scenarios of enhanced mobile broadband (eMBB), massive machine type communications (mMTC), and ultra reliable and low latency communications (URLLC); and

FIG. 15 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

[Unlicensed Frequency Band]

In Release 16 NR, for example, NR-Unlicensed (or also referred to as NR-U) is considered to be introduced, in which communication based on an NR radio access scheme is performed in an unlicensed frequency band (or also referred to as an unlicensed band).

In an unlicensed frequency band, for example, each device performs carrier sensing (also referred to as, for example, listen before talk (LBT)) before transmission in order to confirm whether another system or terminal is using the radio channel. In NR-U, for example, whether transmission is possible is determined based on the result of the LBT, and thus it is considered that a terminal (or also referred to as user equipment (UE)) performs a process for detecting the beginning of transmission of downlink data (e.g., downlink burst (DL burst)) by a base station (also referred to as gNB, for example). In Release 16 NR, for example, the DL burst detection based on a PDCCH is discussed.

Further, enhancement is considered to be implemented in Release 17 NR in order to operate, for example, an ultra reliable and low latency communications (URLLC) service in an unlicensed frequency band. In an unlicensed frequency band, for example, interference from another system or the like possibly occurs. An LBT failure due to the interference from another system or the like, for example, causes a transmission stand-by time and possibly increases the delay.

With this regard, in Release 17 NR, it is discussed to operate the URLLC service in an environment where basically no interference from another system or the like occurs, which is referred to as a “controlled environment”, for example. It is assumed, however, that an abrupt interference possibly occurs in reality even in the controlled environment.

[Configured Grant Transmission]

Configured grant transmission (e.g., configured grant transmission in a licensed frequency band) supported in Release 15 NR will be described.

The configured grant transmission for uplink data (e.g., physical uplink shared channel (PUSCH)) includes, for example, “Configured grant type 1 transmission” and “Configured grant type 2 transmission”.

In Configured grant type 1 transmission, for example, information (referred to as, for example, configured grant configuration information or CG configuration information) such as a modulation and coding scheme (MCS), radio resource allocation (e.g., allocation of at least one of time resources and frequency resources), a transmission timing, and the number of hybrid automatic repeat request (HARQ) processes may be configured (i.e., indicated or instructed) to a terminal by UE-specific higher layer signaling. When uplink data is generated, the terminal may, for example, transmit the uplink data (e.g., PUSCH) based on preconfigured CG configuration information such as an MCS and a radio resource without a UL grant (i.e., dynamic scheduling information for uplink data) via a downlink control channel (e.g., physical downlink control channel (PDCCH)) from a base station.

Note that the higher layer signaling is sometimes referred to as, for example, radio resource control (RRC) signaling, or a higher layer parameter.

In Configured grant type 2 transmission, for example, the configured grant transmission is activated or released by a PDCCH from the base station. In Configured grant type 2 transmission, for example, information such as the transmission timing and the number of HARQ processes may be configured by the UE-specific higher layer signaling as in Configured grant type 1 transmission. Information such as the MCS and radio resource allocation information, however, may be configured by downlink control information (DCI) for activation in Configured grant type 2 transmission. When uplink data is generated, for example, the terminal may transmit the uplink data (e.g., PUSCH) by semi-permanently (i.e., statically or semi-statically) using the CG configuration information such as the MCS and radio resource configured by the higher layer signaling and the DCI for activation (in other words, without a UL grant or UL grant free).

In Release 15 NR, for example, a UL grant is used for retransmission control of the configured grant transmission. For example, an MCS and radio resource allocation information of uplink data for retransmission may be controlled by the UL grant.

Additionally, a HARQ process number (or HARQ process ID) used in the configured grant transmission may be uniquely determined from a slot number for transmitting a PUSCH (i.e., transmission timing of the PUSCH), by way of non-limiting example. The PUSCH transmitted in the configured grant transmission may be handled similar to a signal that is initially transmitted, for example, and the redundancy version (RV) may be zero.

[Configured Grant Transmission in Unlicensed Frequency Band]

In the configured grant transmission in NR-U (NR in an unlicensed frequency band), for example, some of parameters (e.g., parameters on retransmission control) used for decoding a PUSCH, such as a HARQ process number, new data indicator (NDI), and RV, may be indicated from a terminal to a base station by uplink control information for the configured grant transmission (referred to as, for example, configured grant uplink control information (CG-UCI)).

The CG-UCI may be transmitted at the same transmission timing (e.g., the same slot) as the PUSCH (or sometimes referred to as CG-PUSCH), for example, using a part of a radio resource allocated to the PUSCH. In other words, the CG-UCI may be multiplexed with the CG-PUSCH.

The reason why the HARQ process number is explicitly indicated using the CG-UCI in NR-U is as follows. For example, in NR-U, the PUSCH is not always transmitted, depending on the result of the LBT. For example, in a method of determining the HARQ process number linking with a transmission timing of a PUSCH as in a licensed frequency band, the HARQ process may not be flexibly used depending on whether the PUSCH is actually transmitted. Thus, the HARQ process number is possibly indicated using, for example, the CG-UCI transmitted with the CG-PUSCH.

In addition, NR-U supports an operation of retransmission by a terminal using a radio resource configured for the configured grant without UL grant, for example, upon reception of NACK or timer expiration. In this regard, information indicating the state of initial transmission or retransmission (e.g., new data indicator (NDI)) and the RV applied to the PUSCH at the time of retransmission, for example, may be transmitted by the CG-UCI.

In NR-U, for example, HARQ-ACK feedback to the CG-PUSCH may be explicitly indicated from a gNB to UE using information called a downlink feedback indicator (DFI). For example, the HARQ process number for the CG-PUSCH is indicated by the CG-UCI. Thus, when the gNB fails to receive the CG-UCI, for example, the gNB possibly fails to specify which HARQ process data has been transmitted, and it is sometimes not possible to specify the HARQ process and indicate retransmission of the PUSCH. With this regard, the gNB may indicate (i.e., feed back) HARQ-ACK feedback information for all HARQ processes, for example. The gNB can reduce the overhead caused by the LBT and improve the efficiency of retransmission control by, for example, collectively feeding back HARQ-ACK feedback information for a plurality of PUSCHs to the terminal.

Note that, in retransmission control by the DFI, the MCS and radio resource allocation for the retransmission PUSCH may be the same as in the initial transmission. The DFI may be transmitted in the PDCCH, for example. Further, the DFI may include, for example, another parameter such as a transmission power control (TPC) command in addition to the HARQ-ACK.

In an embodiment of the present disclosure, a description will be given of a method of increasing transmission occasions for an uplink signal (e.g., CG-PUSCH) in the above-described unlicensed frequency band. The increase in transmission occasions for an uplink signal makes it possible to improve communication reliability and reduce the delay, for example. In addition, according to an embodiment of the present disclosure, even when an abrupt interference occurs in operating an URLLC service in the unlicensed band, for example, the increase in transmission occasions for an uplink signal makes it easier to meet a requirement of the URLLC.

[Transmission/Reception Success Rate in Configured Grant]

The success rate of configured grant PUSCH (e.g., CG-PUSCH) reception may be based on, for example, the number of radio resources that are configured for the configured grant and available at a certain timing (hereinafter, referred to as “CG resources”). In a case of N CG resources (e.g., case where N CG resources are configured for a terminal in advance and the terminal can select a CG resource for transmitting a CG-PUSCH among the N CG resources), for example, the success rate of the CG-PUSCH transmission/reception may be calculated according to the following Expressions 1 and 2:

[1]

P_{CG-PUSCH}≅P_{LBT}·P_{CG-UCI}·P_{CG-PUSCH}_{_{data}} (Expression 1); and

[2]

P_{LBT}=1−Πₙ₌₀^{N-1}(1−P_{LBT,n}) (Expression 2).

Here, “P_{CG-PUSCH}” represents a success rate of CG-PUSCH transmission/reception, “P_{CG-UCI}” represents a success rate of CG-UCI decoding, and “P_{CG-PUSCHdata}” represents a success rate of decoding of a CG-PUSCH alone (e.g., CG-PUSCH in a case where control information (CG-UCI) is properly acquired). Further, “P_{LBT}” represents a success rate of LBT, and “P_{LBT,n}” represents a success rate of LBT in the n-th CG resource of N CG resources.

For example, control information included in the CG-UCI transmitted with the CG-PUSCH is used for CG-PUSCH reception, and thus a parameter on the CG-UCI may be included in the expression for the success rate of CG-PUSCH transmission/reception represented by Expression 1.

In Expression 1, for example, the success rate of CG-PUSCH transmission/reception P_{CG-PUSCH} is possibly low when “P_{LBT}” is low while the value of “P_{CG-UCI}*P_{CG-PUSCHdata}” is high. For example, when P_{CG-UCI}*P_{CG-PUSCHdata}=1-10⁻⁵ (e.g., 99.999%) and P_{LBT}=1-10⁻² (99%), the success rate of CG-PUSCH transmission/reception P_{CG-PUSCH} is approximately 98.999%, which is lower than the success rate of CG-UCI and CG-PUSCH decoding (P_{CG-UCI}*P_{CG-PUSCHdata})=1-10⁻⁵.

Further, as indicated by Expression 2, the LBT success rate P_{LBT} can be improved when more CG resources are available at a certain timing. By way of example, in a case where the LBT success rate in each of N CG resources P_{LBT,n}=1-10⁻² (99%), P_{LBT}=1-10⁻² (99%) when N=1, and P_{LBT}=1-10⁻⁶ (99.9999%) when N=4. In this manner, the greater the value of N is, the lower the failure rate (e.g., term of total power in Expression 2) of LBT in N CG resources is, and this improves the LBT success rate P_{LBT} (i.e., success rate of LBT in at least one of N CG resources).

From the above, to improve the success rate of CG-PUSCH transmission/reception, the LBT success rate needs to be improved, for example. To improve the LBT success rate, there needs to be a plurality of CG resources available for a terminal at a certain timing. In other words, transmission occasions for an uplink signal for a terminal need to be increased.

With this regard, in an embodiment of the present disclosure, a plurality of CG resources (i.e., resource candidates) may be configured for a terminal, for example. The terminal may transmit an uplink signal using any resource (e.g., resource where LBT has succeeded) of the plurality of configured CG resources, for example.

[Relationship Between Increase in Transmission Occasions and Processing Time in Terminal]

As described above, to increase transmission occasions for an uplink signal for a terminal, a plurality of CG resources (also referred to as transmission resources or LBT occasions) may be configured for the terminal at a certain timing, for example.

The CG resource may be, for example, a unit of resource where carrier sensing (e.g., LBT) is performed. The CG resource may be, for example, a resource unit such as a resource block set (RB set), band width part (BWP), or carrier (e.g., component carrier (CC)), or may be a resource unit obtained by dividing the RB set, BWP, or carrier.

For example, even when the terminal transmits a CG-PUSCH in any of the plurality of CG resources, it is assumed that the terminal prepares for CG-PUSCH transmission (e.g., data encoding processing, etc.) for each of the plurality of CG resources. This is because the terminal possibly fails to start the CG-PUSCH transmission in time if preparing for the CG-PUSCH transmission after the LBT result comes out since the preparation time is limited from the LBT result coming out until the start of the CG-PUSCH transmission.

With this regard, when a plurality of CG resources available at a certain timing are configured for the terminal, the processing time for the CG-PUSCH transmission is expected to be reduced. The plurality of CG resources may be frequency division multiplexed or space division multiplexed, for example.

In an embodiment of the present disclosure, a description will be given of methods of reducing the processing time for CG-PUSCH transmission when a plurality of CG resources are configured for a terminal. Exemplary methods for enabling the reduction in the processing time for CG-PUSCH transmission include a method of reducing the processing time as compared with a case of respectively preparing for the CG-PUSCH transmission for a plurality of CG resources in parallel, or a method of reducing the processing time for preparing for the CG-PUSCH transmission for each of the plurality of CG resources (i.e., single CG resource).

### Embodiment 1

[Overview of Communication System]

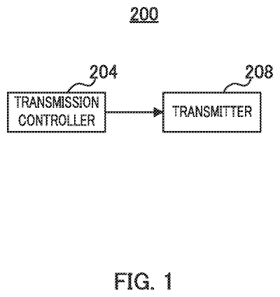

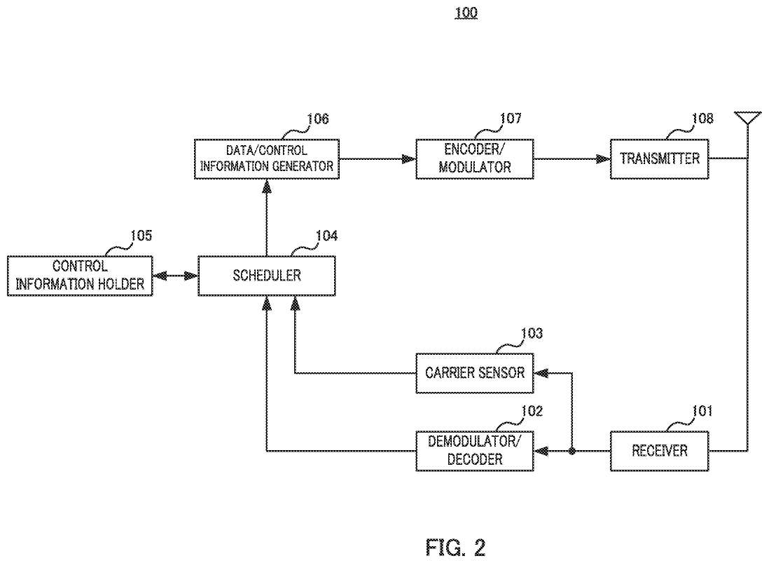

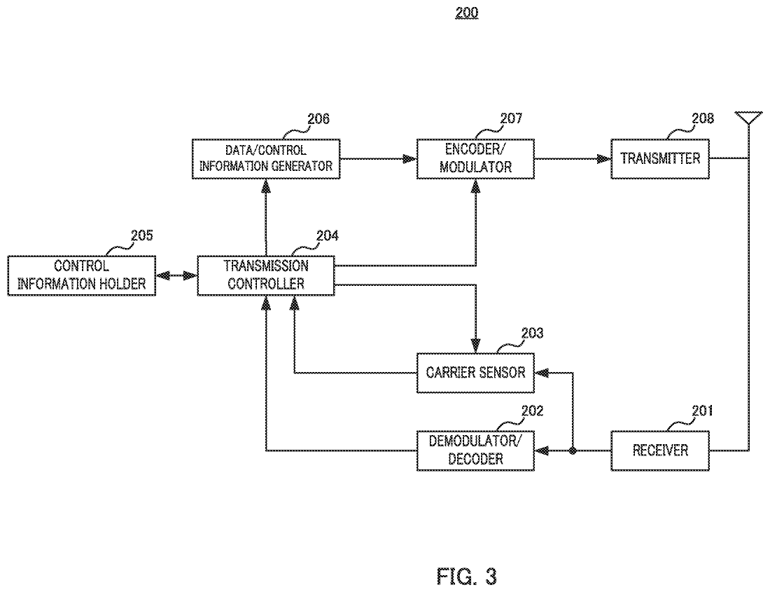

A communication system according to an embodiment of the present disclosure may include, for example, base station 100 (e.g., gNB) illustrated in FIG. 2 and terminal 200 (e.g., UE) illustrated in FIGS. 1 and 3. The communication system may include a plurality of base stations 100 and terminals 200.

FIG. 1 is a block diagram illustrating an exemplary configuration of a part of terminal 200 according to an embodiment of the present disclosure. In terminal 200 illustrated in FIG. 1, transmission controller 204 (corresponding to control circuitry) determines an available resource candidate by carrier sensing from a plurality of resource candidates (e.g., CG resources) that are based on a unit of the carrier sensing. Transmitter 208 (corresponding to transmission circuitry) transmits an uplink signal in the available resource candidate.

[Configuration of Base Station]

FIG. 2 is a block diagram illustrating an exemplary configuration of base station 100 according to an embodiment of the present disclosure. In FIG. 2, base station 100 includes receiver 101, demodulator/decoder 102, carrier sensor 103, scheduler 104, control information holder 105, data/control information generator 106, encoder/modulator 107, and transmitter 108.

For example, receiver 101 performs reception processing such as down-conversion or A/D conversion on a received signal received via an antenna, and outputs the received signal after the reception processing to demodulator/decoder 102 and carrier sensor 103. The received signal may include, for example, a signal transmitted from terminal 200 (e.g., uplink signal) or a signal of another system.

Demodulator/decoder 102, for example, demodulates and decodes the received signal (e.g., uplink signal) inputted from receiver 101, and outputs the decoding result to scheduler 104.

Carrier sensor 103 may perform carrier sensing (e.g., LBT), for example, based on the received signal inputted from receiver 101. For example, carrier sensor 103 may determine whether the channel state is either “busy” or “idle” (in other words, whether the channel is available) based on the received signal inputted from receiver 101. Carrier sensor 103 outputs information indicating the determined channel state to scheduler 104. Note that the channel state may be determined for each CC, for each BWP, or for each RB set, for example.

Scheduler 104 determines, for example, CG configuration information (e.g., information such as a transmission period, frequency domain resource, time domain resource, or MCS) for terminal 200, and outputs the determined CG configuration information to control information holder 105. In addition, scheduler 104 may indicate generation of data or control information to data/control information generator 106 based on, for example, the information indicating the channel state inputted from carrier sensor 103 or the decoding result inputted from demodulator/decoder 102. For example, in a case where signaling information including the CG configuration information is transmitted, scheduler 104 may indicate generation of the signaling information to data/control information generator 106.

Control information holder 105 holds, for example, control information such as the CG configuration information for each terminal 200. Control information holder 105 may, for example, output the held information to respective components (e.g., scheduler 104) of base station 100 as needed.

Data/control information generator 106, for example, generates data or control information in accordance with the indication from scheduler 104, and outputs a signal including the generated data or control information to encoder/modulator 107. For example, data/control information generator 106 may generate data including signaling information based on the indication of signaling information generation inputted from scheduler 104, and output the generated data to encoder/modulator 107.

Encoder/modulator 107, for example, encodes and modulates the signal inputted from data/control information generator 106, and outputs the modulated transmission signal to transmitter 108.

Transmitter 108 performs transmission processing such as D/A conversion, up-conversion, or amplification on the signal inputted from encoder/modulator 107, and transmits a radio signal obtained by the transmission processing from the antenna to terminal 200.

[Configuration of Terminal]

FIG. 3 is a block diagram illustrating an exemplary configuration of terminal 200 according to an embodiment of the present disclosure. In FIG. 3, terminal 200 includes receiver 201, demodulator/decoder 202, carrier sensor 203, transmission controller 204, control information holder 205, data/control information generator 206, encoder/modulator 207, and transmitter 208.

For example, receiver 201 performs reception processing such as down-conversion or A/D conversion on a received signal received via an antenna, and outputs the received signal after the reception processing to demodulator/decoder 202 and carrier sensor 203. The received signal may include, for example, a signal transmitted from base station 100 (e.g., downlink signal) or a signal of another system.

Demodulator/decoder 202, for example, demodulates and decodes the received signal (e.g., downlink signal) inputted from receiver 201, and outputs the decoding result to transmission controller 204.

Carrier sensor 203 may perform carrier sensing (or LBT) based on, for example, a carrier sensing indication from transmission controller 204 and the received signal inputted from receiver 201. For example, carrier sensor 203 may determine whether the channel state is either “busy” or “idle” (in other words, whether the channel is available) based on the received signal inputted from receiver 201. Carrier sensor 203 outputs information indicating the determined channel state to transmission controller 204. Note that the channel state may be determined for each CC, for each BWP, or for each RB set, for example.

Transmission controller 204 outputs, to control information holder 205, signaling information (e.g., CG configuration information) included in the decoding result inputted from demodulator/decoder 202, for example. In addition, transmission controller 204 may indicate generation of data or control information to data/control information generator 206 based on, for example, control information such as the CG configuration information inputted from control information holder 205. Transmission controller 204 may also indicate carrier sensing to carrier sensor 203, for example. Further, transmission controller 204 determines a resource to be used for transmitting an uplink signal based on, for example, the information indicating the channel state inputted from carrier sensor 203, and outputs resource information indicating the determined resource to encoder/modulator 207.

Control information holder 205 holds, for example, control information such as the signaling information (e.g., CG configuration information) inputted from transmission controller 204, and outputs the held information to respective components (e.g., transmission controller 204) as needed.

Data/control information generator 206, for example, generates data or control information in accordance with the indication from transmission controller 204, and outputs a signal including the generated data or control information to encoder/modulator 207. For example, data/control information generator 206 may generate data including the signaling information based on the indication of signaling information generation inputted from scheduler 204, and output the generated data to encoder/modulator 207.

Encoder/modulator 207, for example, encodes and modulates the signal inputted from data/control information generator 206 based on the resource information inputted from transmission controller 204, and outputs the modulated transmission signal to transmitter 208.

Transmitter 208 performs transmission processing such as D/A conversion, up-conversion, or amplification on the signal inputted from encoder/modulator 207, and transmits a radio signal obtained by the transmission processing from the antenna to base station 100.

[Operations of Base Station 100 and Terminal 200]

Exemplary operations in base station 100 and terminal 200 having the above configurations will be described.

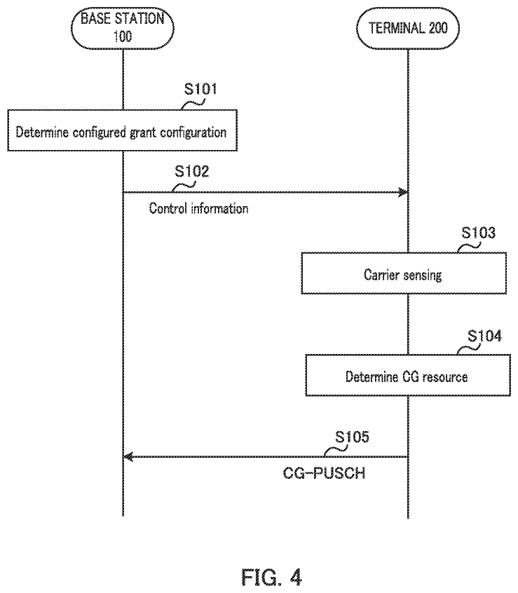

FIG. 4 is a sequence diagram describing exemplary operations of base station 100 and terminal 200.

Base station 100 determines, for example, a configured grant configuration for terminal 200 (S101). The configured grant configuration may include, for example, information on the MCS, radio resource allocation, transmission timing, and HARQ process. In addition, base station 100 may configure, for terminal 200, a plurality of CG resources (i.e., resource candidates) in units of performing carrier sensing in an unlicensed frequency band, for example.

Base station 100 transmits control information to terminal 200 (S102). The control information may include, for example, CG configuration information.

Terminal 200 performs, for example, carrier sensing (e.g., LBT) (S103).

Terminal 200 determines a CG resource based on, for example, the CG configuration information and a result of the carrier sensing (S104). For example, terminal 200 may select a CG resource determined to be available by the carrier sensing from the plurality of CG resources configured in the unlicensed frequency band.

For example, terminal 200 transmits a CG-PUSCH in the determined CG resource (S105). Base station 100, for example, receives the CG-PUSCH in the CG resource determined to be available by the carrier sensing of terminal 200 among the plurality of CG resources configured for terminal 200.

[CG Resource Configuration Method and CG-PUSCH Transmission Method]

Descriptions will be given of exemplary methods of configuring CG resources (e.g., physical resources for CG transmission) by base station 100 (e.g., scheduler 104) and terminal 200 (e.g., transmission controller 204), and exemplary methods of transmitting a CG-PUSCH by terminal 200 when a plurality of CG resources are configured.

Terminal 200 may control the CG-PUSCH transmission based on a configuration of the plurality of CG resources in an RB set, BWP, or CC, for example.

<Configuration Method 1>

In Configuration Method 1, a common parameter may be configured for a plurality of CG resources (e.g., RB sets, BWPs, or CCs) configured for terminal 200. In other words, the plurality of CG resources may be linked with a common parameter.

For example, some of a plurality of parameters configured for each CG resource may be commonly configured among the plurality of CG resources, and other parameters may be configured for each of the plurality of CG resources.

For example, the parameters commonly configured among the plurality of CG resources may include a parameter on processing before resource mapping (e.g., up to encoding process). The parameters commonly configured among the plurality of CG resources may include, for example, parameters such as the number of RBs, the number of symbols, MCS, the number of layers, and the number of demodulation reference signal (DMRS) symbols. By configuring common values to these parameters for the plurality of CG resources, for example, the processing before resource mapping in terminal 200 can be shared among the plurality of CG resources.

In addition, the parameters individually configured for each of the plurality of CG resources may include, for example, a parameter on processing at or after resource mapping (e.g., parameter such as position in frequency domain).

For example, when the processing before resource mapping is shared among a plurality of CG resources in terminal 200, terminal 200 may perform processing in the following order of 1, 2, and 3.
1. Terminal 200 sets a common value among the plurality of CG resources to a parameter used for the processing before resource mapping.
2. Terminal 200 performs processing up to CG-PUSCH resource mapping for one of the plurality of CG resources.
3. Terminal 200 determines a CG resource for transmitting a CG-PUSCH among the plurality of CG resources based on the LBT result, and transmits the CG-PUSCH mapped to the determined CG resource.

As described above, by sharing the processing before resource mapping with the plurality of CG resources, for example, terminal 200 can reduce the processing time compared to a case of performing the processing before resource mapping for each of the plurality of CG resources in parallel.

For example, in a case of sharing a configuration with a plurality of CG resources, signaling overhead possibly increases when a parameter is individually configured (i.e., instructed or indicated) for each CG resource. Thus, base station 100 and terminal 200 may duplicate a parameter for a single CG resource and configure the parameter for each of the plurality of CG resources, for example.

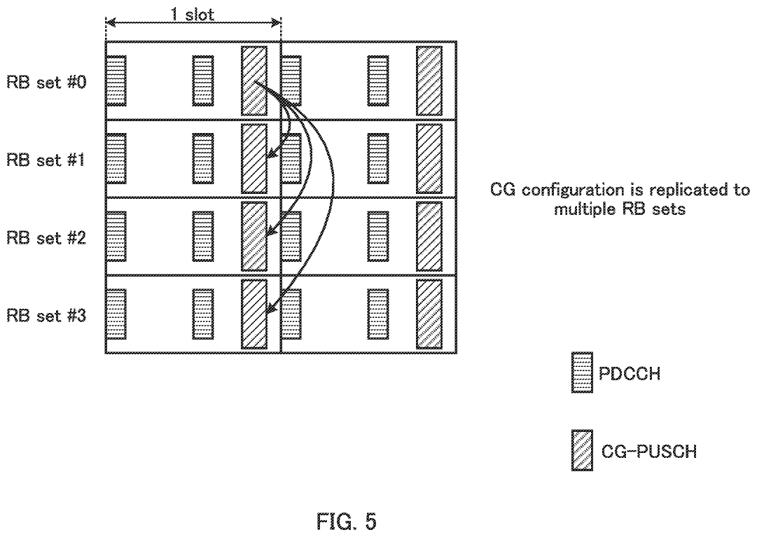

FIG. 5 illustrates an exemplary parameter configuration in a case where the CG resource is an RB set, by way of example. In FIG. 5, terminal 200 is configured with four RB sets #0 to 3, for example. Note that the number of RB sets configured for terminal 200 is not limited to four and may be another number.

For example, in a case where a common parameter is configured for the four RB sets, base station 100 may indicate, to terminal 200, a set of parameters on the CG resource (e.g., parameters included in ConfiguredGrantConfig in NPL 5). In other words, base station 100 need not individually indicate a common parameter to the plurality of RB sets configured for terminal 200.

Further, base station 100 may indicate, to terminal 200, a 4-bit bitmap corresponding to (i.e., linked with) the number of RB sets configured for terminal 200, for example.

Each of the bits composing the bitmap may correspond to, for example, each of the RB sets configured for terminal 200. For example, when a set value of the bit is “1”, a common parameter on the CG resource indicated from base station 100 to terminal 200 may be applied to the corresponding RB set. Meanwhile, when a set value of the bit is “0”, for example, a common parameter on the CG resource indicated from base station 100 to terminal 200 need not be applied to the corresponding RB set. For example, a parameter other than the common parameter may be individually configured for the RB set corresponding to the bit set value “0”.

For example, in FIG. 5, when the 4-bit bitmap of “1111” corresponds to four RB sets #0 to #3, terminal 200 may duplicate one set of parameters (i.e., CG configuration information) on the CG resource of RB set #0, and configure the parameters for each of the other RB sets #1 to #3. Note that the RB set from which the parameters are duplicated is not limited to RB set #0, and parameters configured for any of RB sets #1 to #3 may be configured for the other RB sets, for example.

This method allows terminal 200 to configure a plurality of CG resources using a single parameter set indicated from base station 100, for example, thereby preventing increase in signaling overhead.

For example, in a case where some of the parameters configured for the CG resource are shared by (i.e., set common among) a plurality of CG resources, the parameters to be shared may be grouped, and the duplication of the parameters for the plurality of CG resources may be applied to the group. Meanwhile, parameters not included in the group may be configured for each CG resource.

Further, in Configured grant type 2 transmission, for example, base station 100 may configure, for terminal 200, a CG resource for enabling (i.e., disabling) the common parameter application using a DCI for activation. For example, base station 100 may indicate, in the DCI for activation, the bitmaps respectively corresponding to a plurality of RB sets configured for terminal 200. The bitmap may indicate, for example, whether to enable the common parameter application related to the CG resource for the plurality of RB sets.

For the indication of the bitmap by the DCI for activation, for example, a field that is not used (or has lower priority) for the DCI for activation may be reused. The field possibly reused includes, for example, fields for parameters such as a HARQ process number, RV, downlink assignment index (DAI), or TPC. In addition, a plurality of the above-described fields may be combined according to the number of bits corresponding to the number of CG resources (e.g., the number of RB sets) configured for terminal 200, and used for the indication of the bitmap. This enables a plurality of CC resources without increasing bits.

For example, in a case where a common parameter is applied to a plurality of RB sets in order to share the processing before resource mapping, even when the positions in the frequency domain in the RB sets are different from each other, the processing before resource mapping can be shared when the number of RBs to be used is the same. For example, when the number of RBs is the same and the size of the physical resource is the same in the plurality of CG resources, processing such as rate matching can be shared. Thus, a plurality of CG resources may be mapped in different positions in RB sets, BWPs, and CCs, for example. Mapping the CG resources in different positions improves utilization efficiency of the resources even when the usage status or congestion level of the resources in the RB set, BWPs, and CCs are different.

As described above, in Configuration Method 1, a plurality of CG resources available at a certain timing are configured for terminal 200, for example. This allows terminal 200 to transmit an uplink signal (e.g., CG-PUSCH), for example, as long as a certain CG resource is available among the plurality of CG resources configured for terminal 200 even when another CG resource cannot be used due to an LBT failure, thereby increasing transmission occasions for an uplink signal for terminal 200 and reducing the delay.

In addition, for a plurality of CG resources configured for terminal 200, for example, a parameter used for the processing before resource mapping (e.g., processing up to encoding process) may be set to a common value. This allows terminal 200 to generate encoded data of the CG-PUSCH in a single CG resource for a plurality of CG resources (e.g., RB sets), for example. Accordingly, terminal 200 can reduce the processing time, for example, as compared with a case of performing the processing up to encoding process (i.e., preparation for CG-PUSCH transmission) for each of the plurality of CG resources in parallel.

Thus, according to Configuration Method 1, even when a plurality of CG resources are configured, terminal 200 can reduce the processing time for CG-PUSCH transmission and improve the transmission occasions for an uplink signal, thereby improving the communication reliability and reducing the delay.

Note that, although the duplication of a parameter is applied to a resource in the frequency domain in the above example, the present disclosure is not limited to this. For example, the above-described duplication of a parameter may be applied to a resource in the time domain. For example, a periodicity (e.g., parameter for configuring a transmission period of CG-PUSCH) may be used for configuring the CG resource in the time domain. Although the periodicity supports, for example, transmission with constant intervals (e.g., 14-symbol intervals), a transmission interval other than the constant interval can be supported, for example, by applying a duplicate parameter using a bitmap to the resource in the time domain. This prevents increase in signaling overhead, and increases transmission occasions in the time domain more flexibly.

Further, although the RB set is used as an exemplary CG resource in the above example, the CG resource is not limited to the RB set. For example, a plurality of BWPs or a plurality of CCs may be configured for terminal 200 at a certain timing.

<Configuration Method 2>

In Configuration Method 2, terminal 200 may configure the transport block (TB) size based on the number of CG resources configured for terminal 200. For example, terminal 200 may configure (e.g., limit) the maximum TB size based on the number of CG resources.

The encoding processing time possibly depends on the size of data, for example. Thus, limiting the TB size, for example, reduces the encoding processing time, accordingly, the processing time in terminal 200 for transmitting a CG-PUSCH in each CG resource is reduced, and the CG-PUSCH transmission is more likely to start in time. In other words, the TB size for each CG resource may be configured such that the processing for the CG-PUSCH transmission for each of the plurality of CG resources does not exceed the processing capability of terminal 200.

For example, in a case where a plurality of CG resources are configured for terminal 200 at a certain timing in an RB set, BWP, or CC, the maximum TB size may be configured (e.g., limited) in accordance with the number of CG resources. Exemplary methods of configuring the maximum TB size are as follows.

### Example 1: Method in which an Available MCS Index is Configured in Accordance with the Number of CG Resources

For example, when four CG resources are configured for terminal 200, the maximum TB size may beset to ¼ as compared with the case where a single CG resource is configured. In this case, the MCS index available for terminal 200 may be limited so that the maximum TB size configurable for terminal 200 is ¼.

Note that, when N CG resources are configured, for example, the maximum TB size may be set to 1/N or a ratio other than 1/N as compared with the case where a single CG resource is configured.

### Example 2: Method in which the TB Size is Scaled

Terminal 200 may scale TB size “N_{info}” according to Expression 3, for example:

[3]

N_{info}=S·NRE·R·Qₘ·v (Expression 3).

In Expression 3, “N_{RE}” represents the number of resource elements (REs), “R” represents a target code rate, “Qₘ” represents a modulation level, “v” represents the number of layers, and “S” represents a scaling factor.

For example, terminal 200 may set scaling factor S to 0.25 when four CG resources are configured for terminal 200. Note that, when N CG resources are configured, for example, scaling factor S may be set to 1/N or a ratio other than 1/N.

As described above, according to Configuration Method 2, terminal 200 can reduce the processing time for the CG-PUSCH transmission preparation in each of the plurality of CG resources by configuring (i.e., limiting) the TB size in accordance with the number of CG resources, for example. This reduces the processing time in terminal 200.

The processing time in terminal 200 can be reduced by the TB size configuration, and thus a plurality of CG resources available at a certain timing can be configured for terminal 200, for example, thereby increasing transmission occasions for an uplink signal for terminal 200. This allows terminal 200 to transmit an uplink signal (e.g., CG-PUSCH), for example, as long as a certain CG resource is available among the plurality of CG resources configured for terminal 200 even when another CG resource cannot be used due to an LBT failure.

Thus, according to Configuration Method 2, even when a plurality of CG resources are configured, terminal 200 can reduce the processing time for CG-PUSCH transmission and improve the transmission occasions for an uplink signal, thereby improving the communication reliability and reducing the delay.

<Configuration Method 3>

In Configuration Method 3, terminal 200 uses (i.e., reuses) a TB (e.g., medium access control protocol data unit (MAC PDU)) generated in any one of a plurality of CG resources configured for terminal 200 for a TB in another CG resource.

For example, in a case where a plurality of CG resources available at a certain timing are configured in each RB set, BWP, or CC, terminal 200 may reuse (i.e., copy) a TB generated in a certain CG resource in layer 1 (or also referred to as a physical layer or L1). By reusing a TB, terminal 200 may generate a TB in a single CG resource and need not generate a TB in another CG resource in layer 2 (or also referred to as L2), for example, thereby reducing the TB processing time.

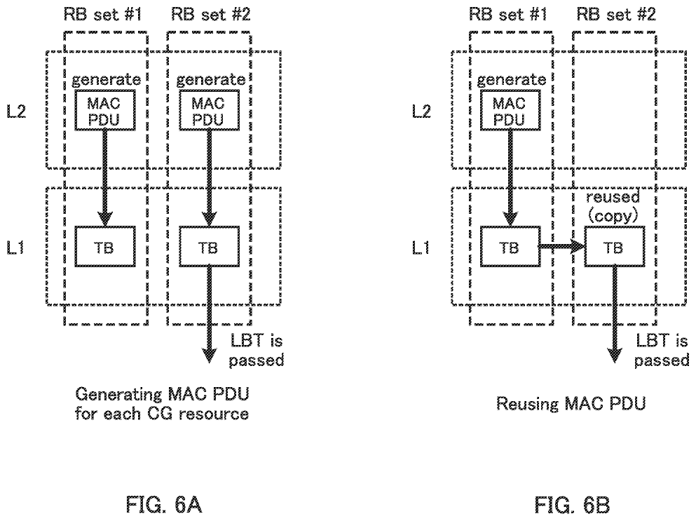

For example, in a case where a TB (e.g., MAC PDU) is generated for each CG resource (RB set in here) in layer 2 as illustrated in FIG. 6A, processing in layer 2 is performed on the TB in each of the plurality of CG resources. In contrast, as illustrated in FIG. 6B, in a case where a TB is generated in one of the plurality of CG resources (RB set #1 in FIG. 6B) in layer 2 and the TB is copied to another CG resource in layer 1, the processing in layer 2 need not be performed in another CG resource (RB set #2 in FIG. 6B). In FIG. 6B, for example, only a single TB needs to be generated in layer 2, thereby reducing the TB processing time as compared with FIG. 6A.

In addition, in a case where the TB size is different among a plurality of CG resources configured for terminal 200, terminal 200 may generate a TB (e.g., MAC PDU) by the processing in layer 2 in a CG resource corresponding to the smallest TB size, for example, and in other CG resources, terminal 200 may generate a TB by padding with respect to the TB with the smallest TB size based on the TB size in each CG resource.

This makes it possible to reuse a TB generated in a certain CG resource for another CG resource even when the TB size is different in a plurality of CG resources. Base station 100, which is a receiving side, may perform reception excluding the padded bits.

As described above, according to Configuration Method 3, terminal 200 can reduce the processing time in layer 2 in a plurality of CG resources by reusing a TB (MAC PDU) generated by the processing in layer 2 in one of the plurality of CG resources, for example, for a TB in another CG resource. This reduces the processing time in terminal 200.

The processing time in terminal 200 can be reduced by reusing the TB, and thus a plurality of CG resources available at a certain timing can be configured for terminal 200, for example, thereby increasing transmission occasions for an uplink signal for terminal 200. This allows terminal 200 to transmit an uplink signal (e.g., CG-PUSCH), for example, as long as a certain CG resource is available among the plurality of CG resources configured for terminal 200 even when another CG resource cannot be used due to an LBT failure.

Thus, according to Configuration Method 3, even when a plurality of CG resources are configured, terminal 200 can reduce the processing time for CG-PUSCH transmission and improve the transmission occasions for an uplink signal, thereby improving the communication reliability and reducing the delay.

Configuration Methods 1 to 3 have been described, thus far.

In the present embodiment, terminal 200 configures a plurality of CG resources (i.e., resource candidates) in units of performing LBT in an unlicensed band, and transmits an uplink signal (e.g., CG-PUSCH) in a CG resource determined to be available by LBT among the plurality of configured CG resources.

This processing allows terminal 200 to transmit an uplink signal using any resource (e.g., resource where LBT has succeeded) of the plurality of configured CG resources. In other words, terminal 200 can increase transmission occasions for an uplink signal. Thus, even when an abrupt interference occurs in operating an URLLC service in the unlicensed frequency band, for example, the increase in transmission occasions for an uplink signal makes it easier to meet a requirement of the URLLC.

Further, in the present embodiment, terminal 200 can reduce the processing time for CG-PUSCH transmission by, for example, using a common parameter, configuring the TB size in accordance with a configured CG resource, or reusing a TB among a plurality of CG resources. This makes it easier for terminal 200 to complete the processing for CG-PUSCH transmission by the time the CG-PUSCH transmission starts from the time the LBT result comes out even when, for example, a plurality of CG resources are configured for terminal 200.

### Embodiment 2

For example, when all channels (or RB sets) included in a BWP or CC subject to carrier sensing (e.g., LBT) are busy, a base station and a terminal wait for transmission and reception until a channel becomes idle, which possibly increases the delay time.

In the present embodiment, for example, a plurality of BWPs or CCs may be configured for a terminal. Descriptions will be given of methods of raising a possibility of detecting an idle channel and increasing transmission occasions for an uplink signal by switching a BWP or CC where carrier sensing is performed among the plurality of BWPs or CCs configured for terminal 200.

In exemplary configurations of the base station and the terminal according to the present embodiment, for example, some functions may be different from the functions in Embodiment 1 and the other functions may be the same as the functions in Embodiment 1.

In base station 100 (FIG. 2), scheduler 104 may control scheduling for terminal 200, for example, assuming terminal 200's operation of switching (selecting or determining) a BWP or CC where carrier sensing is performed.

In terminal 200 (FIG. 3), for example, transmission controller 204 may determine a BWP or CC where carrier sensing is performed based on a channel state (e.g., busy or idle) inputted from carrier sensor 203, and indicate the determination result (e.g., information on the BWP or CC where carrier sensing is performed) to carrier sensor 203.

Carrier sensor 203 may determine the BWP or CC where carrier sensing is performed, for example, based on the information inputted from transmission controller 204.

[Operations of Base Station 100 and Terminal 200]

Exemplary operations in base station 100 and terminal 200 having the above configurations will be described.

<Switching Method 1>

In Switching Method 1, terminal 200 may switch the BWP or CC where carrier sensing is performed in time division, for example. In other words, the BWP or CC where LBT is performed may be switched every specified period.

For example, terminal 200 may switch the BWP or CC where LBT is performed at a certain time granularity (e.g., 9 microseconds (us)). Note that the granularity for switching the BWP or CC where LBT is performed is not limited to 9 us, and may be another granularity.

It is assumed in Switching Method 1 that a plurality of BWPs or CCs are active and a BWP or CC where terminal 200 can perform LBT at a certain timing is one of the active BWPs or CCs, for example.

Exemplary methods of switching the BWP or CC where LBT is performed include the following, for example.

### Example 1

For example, terminal 200 may switch the BWP or CC where LBT is performed from among the configured BWPs or CCs in accordance with the order determined by terminal 200.

Terminal 200 may perform LBT in a BWP or CC switched in any order, for example, among the plurality of configured BWPs or CCs. This processing allows terminal 200 to use, for example, a BWP or CC where LBT has succeeded at an earlier timing (i.e., BWP or CC where the channel is determined to be idle) for transmitting an uplink signal.

### Example 2

For example, terminal 200 may switch the BWP or CC where LBT is performed from among the configured BWPs or CCs in accordance with the order specified in the standard (or specification) or the order configured by signaling.

When the channel state of the BWP or CC currently subject to LBT is busy, for example, terminal 200 may perform LBT in the next BWP or CC. In other words, the switching of the BWP or CC where LBT is performed includes, for example, performing LBT for another BWP or CC when a certain BWP is not available as a result of LBT.

Note that the order of the BWP or CC where LBT is performed, for example, may be in accordance with the priority order of the BWP or CC used for transmitting an uplink signal. For example, by configuring different orders among different terminals 200, terminals 200 are more likely to select different BWPs or CCs at a certain timing, and thus transmission signals of the plurality of terminals 200 are less likely to collide with each other.

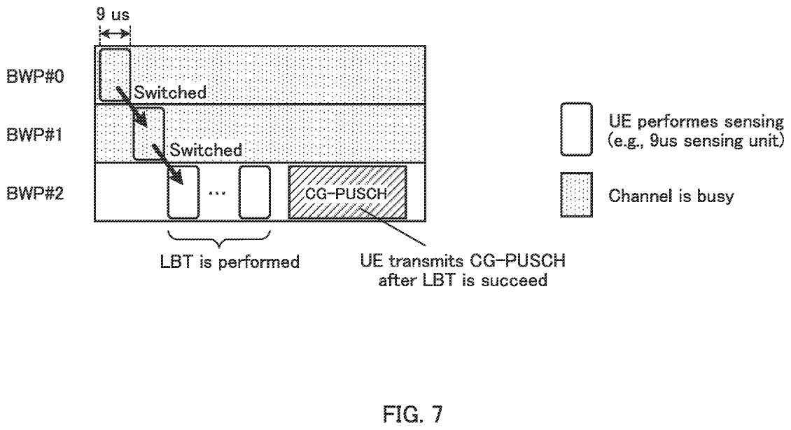

FIG. 7 illustrates exemplary switching of the BWP or CC where LBT is performed according to Switching Method 1.

In FIG. 7, for example, BWP #0, BWP #1, and BWP #2 are configured for terminal 200. In FIG. 7, for example, the order of the BWP where LBT is performed is configured to be the order of BWP #0, BWP #1, and BWP #2. Note that the number of BWPs configured for terminal 200 is not limited to three, and may be another number.

In FIG. 7, terminal 200 may, for example, perform LBT in BWP #0 and switch the BWP where LBT is performed from BWP #0 to BWP #1 as the channel state is busy. Likewise, terminal 200 may, for example, perform LBT in BWP #1 and switch the BWP where LBT is performed from BWP #1 to BWP #2 as the channel state is busy. Then, terminal 200 may, for example, perform LBT in BWP #2 and transmit a CG-PUSCH in BWP #2 as the channel state is idle.

As described above, in Switching Method 1, even when the LBT failure occurs (channel is busy), terminal 200 can raise the possibility of success in LBT and increase transmission occasions for an uplink signal by switching to another BWP or CC.

Further, in Switching Method 1, terminal 200 performs LBT for any one of a plurality of configured BWPs or CCs in accordance with a configured order, thereby reducing the power consumption as compared with a case of performing LBT at a time for the plurality of BWPs or CCs configured for terminal 200.

Note that, although the BWP and CC have been described here, Switching Method 1 may also be applied to the RB set. For example, in a case where terminal 200 fails to simultaneously perform LBT for a plurality of RB sets due to the capability of terminal 200, the RB set where LBT is performed may be switched in time division.

<Switching Method 2>

In Switching Method 2, for example, terminal 200 may switch an active BWP in a plurality of BWPs based on the order specified or configured in the standard.

It is assumed in Switching Method 2 that a single BWP is active among a plurality of BWPs configured for terminal 200, for example.

Terminal 200 may switch an active BWP in the plurality of configured BWPs, for example, when no DL burst is detected.

Here, the channel access scheme includes, for example, frame based equipment (FBE) and load based equipment (LBE: also referred to as dynamic channel occupancy).

In the FBE, base station 100 may perform LBT and acquire cannel occupancy time (COT) in a period called a fixed frame period (FFP), for example. Terminal 200 may switch an active BWP based on, for example, the presence or absence of a COT structure indication (e.g., indication in DCI format 2_0) from base station 100 at the beginning of the FFP. For example, terminal 200 may switch an active BWP to another BWP when no COT structure indication is detected. Meanwhile, terminal 200 may transmit a CG-PUSCH in a BWP where the COT structure indication is detected, for example.

In the LBE, base station 100 can attempt to acquire the COT at any timing, for example. Thus, in the LBE, it is difficult for terminal 200 to determine the change of the BWP at a predetermined timing as in the FBE. With this regard, terminal 200 may switch an active BWP to another BWP when, for example, receiving no COT structure indication from the base station in a certain period from the last symbol of the currently configured COT based on a timer (or when receiving no indication of COT acquisition). Meanwhile, terminal 200 may transmit a CG-PUSCH in the present active BWP when, for example, receiving the COT structure indication from the base station in a certain period from the last symbol of the COT (or when receiving the indication of COT acquisition).

For example, the switching order of the active BWP in terminal 200 may be configured in advance from base station 100 to terminal 200. This configuration enables mutual recognition of the BWP switching between base station 100 and terminal 200. This configuration enables mutual recognition of the BWP switching between base station 100 and terminal 200. The switching order of the active BWP may be configured semi-statically or dynamically, for example.

The semi-static configuration of the switching order of the active BWP has an advantage that misrecognition is less likely to occur between base station 100 and terminal 200, for example.

Meanwhile, in the dynamic configuration of the switching order of the active BWP, a candidate for the BWP to be switched (e.g., BWP index) may be indicated in advance from base station 100 to terminal 200 using, for example, a PDCCH or group common PDCCH (GC-PDCCH). This allows base station 100 to configure a BWP to be changed to the active BWP for terminal 200 based on the channel availability (whether the channel is idle). Thus, terminal 200 can reduce a situation where transmission and reception cannot be performed due to an LBT failure.

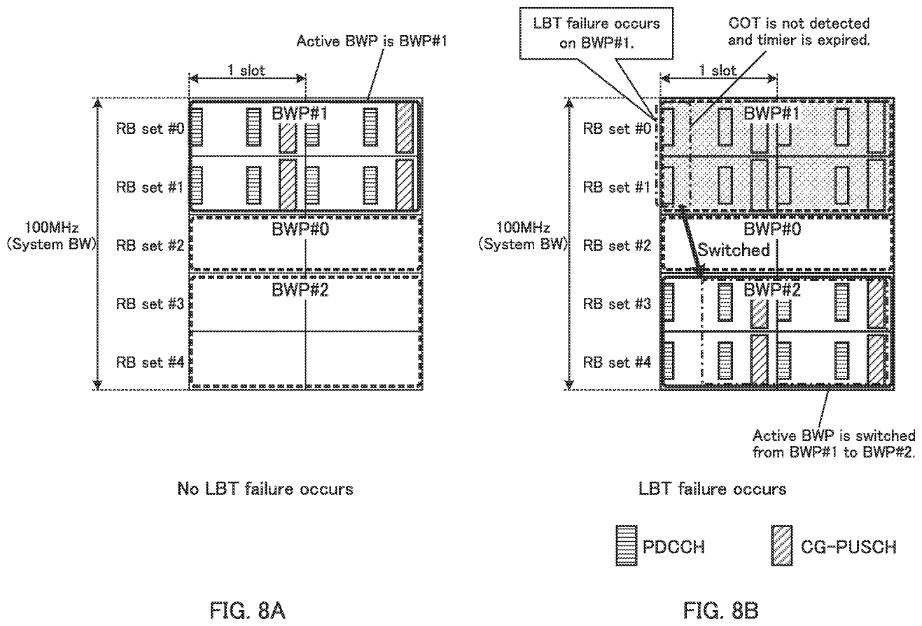

FIG. 8 illustrate exemplary switching of the active BWP (e.g., in the case of LBE) according to Switching Method 2.

In FIGS. 8, for example, BWP #0, BWP #1, and BWP #2 are configured for terminal 200. For example, BWP #1 is configured to be the active BWP at the beginning of the slot in FIG. 8. Note that the number of BWPs configured for terminal 200 is not limited to three, and may be another number.

FIG. 8A illustrates, for example, a case where no LBT failure occurs. In this case, the active BWP for terminal 200 remains BWP #1, and no BWP switching is required. Thus, terminal 200 may transmit a CG-PUSCH in BWP #1, for example.

In contrast, FIG. 8B illustrates, for example, a case where an LBT failure occurs in BWP #1 (e.g., case where base station 100 fails to acquire COT and terminal 200 receives no COT structure indication). In this case, for example, terminal 200 may switch the active BWP to BWP #2 when a certain time elapses (e.g., timer expires) without receiving the COT structure indication. Terminal 200 can perform transmission and reception in BWP #2 when, for example, receiving the COT structure indication at a preconfigured PDCCH reception timing in BWP #2.

As described above, in FIG. 8B, even after the LBT failure occurs in BWP #1, terminal 200 can perform transmission and reception in a different BWP #2, and thus can continue transmission and reception while reducing the delay time. Note that switching between other BWPs may be performed in the same manner.

As described above, in Switching Method 2, even when LBT fails in an active BWP, for example, terminal 200 can increase transmission occasions for an uplink signal by switching the active BWP to another BWP. In addition, LBT is performed in an active BWP in Switching Method 2, thereby reducing the power consumption as compared with a case of performing LBT at a certain timing in a plurality of BWPs configured for terminal 200.

Note that Switching Method 2 is not limited to the change (or switching) of BWPs, and may be applied to a change of CCs, for example. For example, even when a plurality of CCs can be configured to be active according to the capability of terminal 200 (UE), switching the active CC (e.g., secondary cell (Scell)) in the same manner as the BWP described above makes it possible to reduce the number of CCs where terminal 200 transmits and receives signals at a certain timing, thereby reducing the power consumption.

### Embodiment 3

For example, sharing a CG resource with terminals 200 is another exemplary method of increasing transmission occasions for an uplink signal for terminal 200. In the configured grant transmission, for example, the same resource can be configured for a plurality of terminals 200.

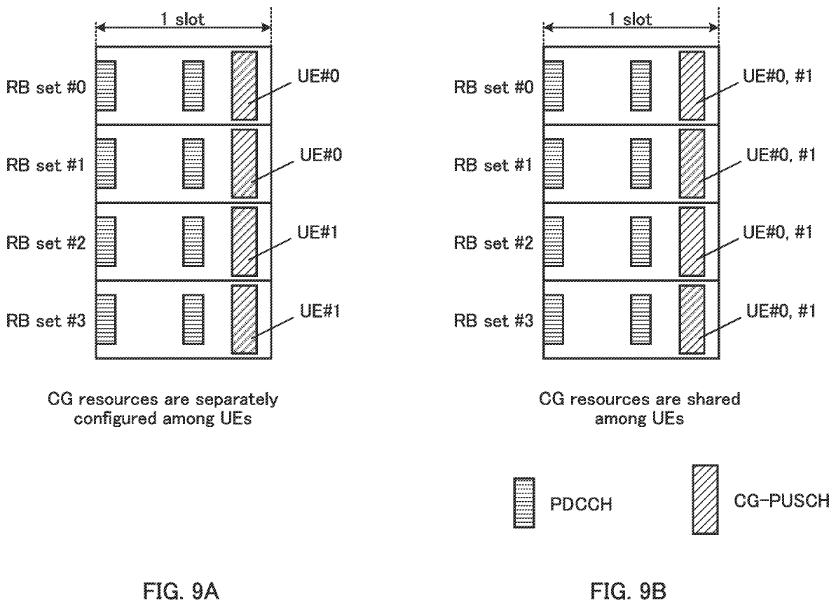

FIG. 9 illustrate examples where four CG resources (RB sets in this example) are allocated for two terminals 200 (e.g., UE #0 and UE #1). FIG. 9A illustrates an example where the CG resources are not shared by the terminals and a single CG resource is allocated for a single terminal 200. FIG. 9B illustrates an example where the four CG resources are shared by two terminals 200.

For example, when RB sets #0 and #1 are busy and RB sets #2 and #3 are idle in FIG. 9A, available CG resources are two sets, which are RB sets #2 and #3, and thus UE #0 waits to transmit an uplink signal. Meanwhile, when RB sets #0 and #1 are busy and RB sets #2 and #3 are idle in FIG. 9B, both UE #0 and UE #1 can transmit an uplink signal using RB sets #2 and #3. Here, in FIG. 9B, when UE #0 and UE #1 use a CG resource in the same RB set, for example, the transmissions of UE #0 and UE #1 possibly collide with each other.

The present embodiment thus provides descriptions of methods for preventing a transmission collision between a plurality of terminals when a CG resource is shared by the plurality of terminals.

In exemplary configurations of the base station and the terminal according to the present embodiment, for example, some functions may be different from the functions in Embodiment 1 and the other functions may be the same as the functions in Embodiment 1.

In base station 100 (FIG. 2), for example, scheduler 104 may control scheduling for terminal 200 assuming an operation of selecting a CG resource to be used for transmission in terminal 200 from among a plurality of CG resources configured for terminal 200 based on a configured or specified selection method (i.e., condition or rule).

In terminal 200 (FIG. 3), for example, transmission controller 204 selects a CG resource to be used for transmission from among a plurality of CG resources configured for terminal 200 based on information (e.g., CG configuration information) inputted from control information holder 205. For example, transmission controller 204 outputs information on the selected CG resource to encoder/modulator 207.

[CG Resource Selection Method]

Exemplary CG resource selection methods in terminal 200 having the above configuration will be described.

When a plurality of CG resources are configured for terminal 200, for example, terminal 200 may select a CG resource for transmitting a CG-PUSCH based on one or more selection methods (i.e., selection rules).

<Selection Method 1>

In Selection Method 1, terminal 200 may select a CG resource to be used for transmitting a CG-PUSCH based on, for example, information on the priority (i.e., selection order) included in a CG configuration.

For example, when different priorities are respectively configured for a plurality of CG resources, terminal 200 may select a CG resource in descending order of the priority.

In Rel. 16, for example, binary priorities of high and low can be configured for terminal 200 by the CG configuration information.

According to Selection Method 1, for example, different priorities can be respectively configured for terminals 200 for each of a plurality of CG resources shared by a plurality of terminals 200. Accordingly, different terminals 200 can easily select different CG resources respectively at a certain timing, for example, thereby preventing a collision of transmissions between terminals 200. Further, using existing signaling to indicate the priority of a CG resource, for example, allows terminal 200 to select a CG resource while preventing increase in signaling overhead.

Note that values including three or more steps may be configured for the value of the priority, for example.

<Selection Method 2>

In Selection Method 2, terminal 200 may select a CG resource to be used for transmitting a CG-PUSCH based on, for example, an index (e.g., ConfiguredGrantConfigIndex) included in a CG configuration.

For example, when CG resources are respectively configured based on a plurality of CG configurations, terminal 200 may select a CG resource in order from a CG resource corresponding to the CG configuration with lower index (or CG resource with higher index).

According to Selection Method 2, for example, different indices can be respectively configured for terminals 200 for each of a plurality of CG resources. Accordingly, different terminals 200 can easily select different CG resources respectively at a certain timing, for example, thereby preventing a collision of transmissions between terminals 200. Further, using existing signaling to indicate the index corresponding to a CG resource, for example, allows terminal 200 to select a CG resource while preventing increase in signaling overhead.

<Selection Method 3>

In Selection Method 3, terminal 200 may select a CG resource to be used for transmitting a CG-PUSCH based on, for example, a selection order configured from base station 100.

For example, the selection order may be configured semi-statically or dynamically.

In addition, the selection order may be configured based on, for example, positions where CG resources such as RB sets, BWPs, or CCs are mapped, and may be configured for each CG configuration.

As an example of configuring the selection order based on the positions where the CG resources are mapped, when the selection order is configured for each RB set, the selection order such as {RB set #0, RB set #1, RB set #2}={1, 2, 0} may be configured. In a case of selecting from the RB set with lower value of the selection order, for example, terminal 200 may transmit a CG-PUSCH using a CG resource of RB set #2 when RB set #2 is idle and is configured with a CG resource. When RB set #2 is busy, terminal 200 may select RB set #0, which corresponds to the next selection order, for example. For RB sets #0 and #1, terminal 200 may control the CG-PUSCH transmission based on the LBT result, as is the case with RB set #2.

Further, as an example of configuring the selection order for each CG configuration, for example, even when CG resources are configured for a plurality of RB sets by a single CG configuration (corresponding to a single index, for example), the selection order can be individually configured for the CG resource based on Selection Method 3.

The semi-static configuration of the selection order has an advantage that misrecognition is less likely to occur between base station 100 and terminal 200, for example.

Meanwhile, in the dynamic configuration of the selection order, for example, information on the selection order may be indicated to terminal 200 from base station 100 by a PDCCH or GC-PDCCH. For example, base station 100 may semi-statically configure a combination (set or candidates) of selection orders to terminal 200, and dynamically indicate an index indicating the combination by a PDCCH or GC-PDCCH. This prevents increase in the number of bits of the PDCCH or GC-PDCCH.

In addition, in the dynamic configuration of the selection order, the selection order can be configured based on, for example, the CG resource usage status of terminals 200 or the occurrence of data transmission and reception, so that the CG transmissions of terminals 200 are less likely to collide with each other.

In addition, the dynamic configuration of the selection order may include a state where a CG resource is unavailable in addition to the CG resource usage order. For example, the selection order may be configured for a certain terminal 200 as follows: {RB set #0, RB set #1, RB set #2}={1, “NA”, 0} indicating that RB set #1 is unavailable (NA). This makes it possible to allocate RB set #1 for another terminal 200, thereby preventing the collision of transmissions between terminals 200 when fewer resources are available for terminal 200.

<Selection Method 4>

In Selection Method 4, terminal 200 may select a CG resource to be used for transmitting a CG-PUSCH based on, for example, the index of the RB set and a UE-specific offset.

For example, when terminals 200 select CG resources based on the index of the RB set, the selection order of the CG resources may be the same among terminals 200. With this regard, in Selection Method 4, terminal 200 determines the selection order based on, for example, the index of the RB set and an offset value for each terminal 200. This causes the selection order to be varied among terminals 200, and prevents a collision of transmissions between terminals 200.

Terminal 200 may calculate a metric value corresponding to the selection order based on the following Expression 4, for example:

[4]

{((RB set index)+offset)mod(the number of RB sets)} (Expression 4).

For example, terminal 200 may select a CG resource of an RB set with lower (or higher) metric value from among RB sets where CG resources are available (e.g., from among RB sets where CG resources are configured and the LBT result is idle).

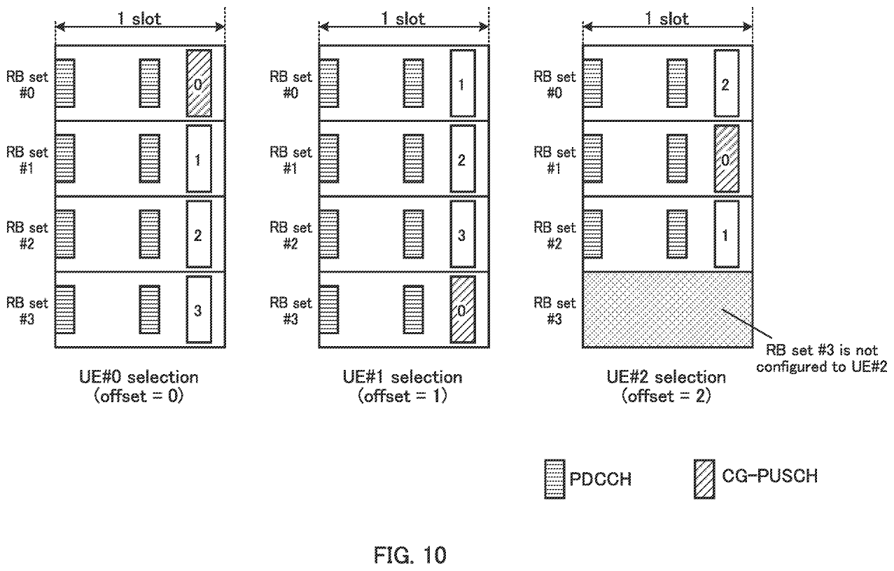

FIG. 10 illustrates exemplary CG resource selection according to Selection Method 4.

FIG. 10 illustrates a case where three terminals 200 (e.g., UE #0, UE #1, and UE #2) share RB sets. For example, UE #0 and UE #1 are configured with four RB sets, which are RB sets #0 to #3. UE #2 is configured with RB sets #0 to #2. In other words, UE #2 is not configured with RB set #3.

In the slot illustrated in FIG. 10, a single CG resource is configured for each RB set. Note that two or more CG resources may be configured for the RB set.

Also, in FIG. 10, offset values 0, 1, and 2 are respectively configured for UE #0, UE #1, and UE #2. Note that the offset value is not limited to any one of 0 to 2, and may be another value.

In this case, metric values respectively configured for the RB sets for UE #0, UE #1, and UE #2 may be calculated according to Expression 4. For example, as illustrated in FIG. 10, metric values 0, 1, 2, and 3 are configured for RB sets #0 to #3 for UE #0, metric values 1, 2, 3, and 0 are configured for RB sets #0 to #3 for UE #1, and metric values 2, 0, and 1 are configured for RB sets #0 to #2 for UE #2.

For example, in the slot illustrated in FIG. 10, UE #0 selects RB set #0, UE #1 selects RB set #3, and UE #2 selects RB set #1. For example, in RB set #0 illustrated in FIG. 10, the metric values (i.e., selection order) for the UEs are different from each other. The same applies to the other RB sets. Thus, it is possible to avoid a collision of transmissions between the UEs in the slot illustrated in FIG. 10.

Note that the offset value may be explicitly indicated to terminal 200 or implicitly determined in terminal 200, for example.

For example, in a method of explicitly indicating the offset value, base station 100 may indicate the offset value to terminal 200 by a semi-static configuration or a dynamic configuration. In the dynamic configuration, for example, the offset value may be indicated using a PDCCH or GC-PDCCH.

The semi-static configuration of the offset value has an advantage that misrecognition is less likely to occur between base station 100 and terminal 200, for example.

Meanwhile, in the dynamic configuration of the offset value, the offset value can be configured based on, for example, the CG resource usage status of terminals 200 or the occurrence of data transmission and reception, so that the CG transmissions of terminals 200 are less likely to collide with each other.

The method of implicitly determining the offset value includes, for example, a method of using a UE ID as the offset value, or a method of using a radio network temporary identifier (RNTI) as the offset value. Note that the information associated with the offset value is not limited to the UE ID and RNTI, and may be other UE-specific information. Terminal 200 may, for example, determine the offset value linked with the UE-specific information. This allows base station 100 to indicate the offset value to terminal 200 while preventing increase in signaling overhead, for example.

Different values may be configured as the offset value among slots, for example. For example, a pseudo-random number different for each slot may be added to the configured offset value. With this configuration, the order of the RB offset selected by terminal 200 changes among slots, resulting in less consecutive collision of transmission of a single terminal 200.

For example, in an RB set with metric value greater than a threshold, terminal 200 may determine non-transmission of an uplink signal. For example, in FIG. 10, the UEs may determine not to transmit an uplink signal in the RB set with metric value of 2 or more. For example, in a case where increased number of RB sets are unavailable due to an LBT failure and transmissions of a plurality of terminals 200 possibly cause a transmission collision between terminals 200, the transmission collision between terminals 200 can be prevented by dividing terminals 200 into terminals that can perform transmission and terminals that cannot perform transmission in each RB set.

CG resource selection methods 1 to 4 have been described, thus far.

As described above, according to the present embodiment, transmissions of a plurality of terminals 200 are less likely to collide with each other in a case where CG resources are shared by terminals 200, thereby improving the resource utilization efficiency.

Embodiments of the present disclosure have been described, thus far.

### Other Embodiments

In the above embodiments, the uplink signal is not limited to an uplink data channel such as the PUSCH or CG-PUSCH, and may be another signal or channel.

In the above embodiments, the “higher layer signaling” may also be referred to as “RRC signaling” or “MAC signaling”, for example.

In the above embodiments, the control signal may be a PDCCH transmitting a DCI of the physical layer, or may be MAC of the higher layer or RRC.

In the above embodiments, the base station may be a transmission reception point (TRP), a clusterhead, an access point, a remote radio head (RRH), an eNodeB (eNB), a gNodeB (gNB), a base station (BS), a base transceiver station (BTS), a base unit, or a gateway, for example. Further, in side link communication, a terminal may be adopted instead of a base station.

In the above embodiments, the reference signals are signals known to both a base station and a mobile station and each reference signal may be referred to as a reference signal (RS) or sometimes a pilot signal. The reference signal may be any of a DMRS, a channel state information-reference signal (CSI-RS), a tracking reference signal (TRS), a phase tracking reference signal (PTRS), and a cell-specific reference signal (CRS).

In the above embodiments, time resource units are not limited to one or a combination of slots and symbols, and may be time resource units, such as frames, superframes, subframes, slots, time slot subslots, minislots, or time resource units, such as symbols, orthogonal frequency division multiplexing (OFDM) symbols, single carrier-frequency division multiplexing access (SC-FDMA) symbols, or other time resource units. The number of symbols included in one slot is not limited to any number of symbols exemplified in the embodiments described above, and may be other numbers of symbols.

The above embodiments may be applied to the communication using the sidelink for vehicle to everything (V2X) or communication between terminals. In this case, the PDCCH may be replaced by a physical sidelink control channel (PSCCH), the PUSCH/PDSCH may be replaced by a physical sidelink shared channel (PSSCH), and the PUCCH may be replaced by a physical sidelink feedback channel (PSFCH).

The embodiments described above may be applied in combination.

<5G NR System Architecture and Protocol Stacks>

3GPP has been working at the next release for the 5th generation cellular technology, simply called 5G, including the development of a new radio (NR) access technology operating in frequencies ranging up to 100 GHz. The first version of 5G standard was initially delivered in late 2017, which allows proceeding to trials and commercial deployments of 5G NR standard-compliant terminals, e.g., smartphones.

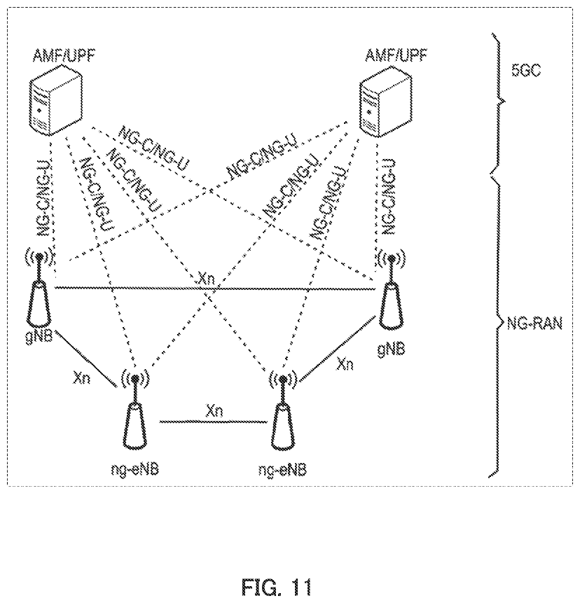

For example, the overall system architecture assumes a Next Generation-Radio Access Network (NG-RAN) that includes gNBs. The gNBs provide the NG-radio access user plane (SDAP/PDCP/RLC/MAC/PHY) and control plane (RRC) protocol terminations towards a UE. The gNBs are interconnected with each other via an Xn interface. The gNBs are also connected to the Next Generation Core (NGC) via the Next Generation (NG) interface, more specifically to the Access and Mobility Management Function (AMF; e.g. a particular core entity performing the AMF) via the NG-C interface, and to the User Plane Function (UPF; e.g. a particular core entity performing the UPF) via the NG-U interface. The NG-RAN architecture is illustrated in FIG. 11 (see, for example, 3GPP TS 38.300 v15.6.0, section 4).

The user plane protocol stack for NR (see, for example, 3GPP TS 38.300, section 4.4.1) includes the Packet Data Convergence Protocol (PDCP, see clause 6.4 of TS 38.300) Radio Link Control (RLC, see clause 6.3 of TS 38.300) and Medium Access Control (MAC, see clause 6.2 of TS 38.300) sublayers, which are terminated in the gNB on the network side. Additionally, a new access stratum (AS) sublayer (Service Data Adaptation Protocol: SDAP) is introduced above the PDCP (see, for example, clause 6.5 of 3GPP TS 38.300). A control plane protocol stack is also defined for NR (see, for example, TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For example, the Medium-Access-Control layer handles logical-channel multiplexing, and scheduling and scheduling-related functions, including handling of different numerologies.

The physical layer (PHY) is, for example, responsible for coding, PHY HARQ processing, modulation, multi-antenna processing, and mapping of the signal to the appropriate physical time-frequency resources. The physical layer also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For example, the physical channels include a Physical Random Access Channel (PRACH), Physical Uplink Shared Channel (PUSCH), and Physical Uplink Control Channel (PUCCH) as uplink physical channels, and a Physical Downlink Shared Channel (PDSCH), Physical Downlink Control Channel (PDCCH), and Physical Broadcast Channel (PBCH) as downlink physical channels.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, the eMBB is expected to support peak data rates (20 Gbps for downlink and 10 Gbps for uplink) and user-experienced data rates in the order of three times what is offered by IMT-Advanced. Meanwhile, in a case of the URLLC, the tighter requirements are put on ultra-low latency (0.5 ms for each of UL and DL for user plane latency) and high reliability (1-10-5 within 1 ms). Finally, the mMTC may preferably require high connection density (1,000,000 devices/km2 in an urban environment), large coverage in harsh environments, and extremely long-life battery for low cost devices (15 years).

Thus, the OFDM numerology (e.g., subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (also referred to as TTI) than an mMTC service. Furthermore, deployment scenarios with large channel delay spreads may preferably require a longer CP duration than scenarios with short delay spreads. The subcarrier spacing may be optimized accordingly to retain the similar CP overhead. NR may support more than one value of subcarrier spacing. Correspondingly, subcarrier spacing of 15 kHz, 30 kHz, 60 kHz . . . are currently considered. The symbol duration Tu and the subcarrier spacing Δf are directly related through the formula Δf=1/Tu. In a similar manner as in LTE systems, the term “resource element” can be used to denote a minimum resource unit being composed of one subcarrier for the length of one OFDM/SC-FDMA symbol.

In the new radio system 5G-NR, for each numerology and carrier, a resource grid of subcarriers and OFDM symbols is defined for each of uplink and downlink. Each element in the resource grid is called a resource element and is identified based on the frequency index in the frequency domain and the symbol position in the time domain (see 3GPP TS 38.211 v15.6.0).

<5G NR Functional Split Between NG-RAN and 5GC>

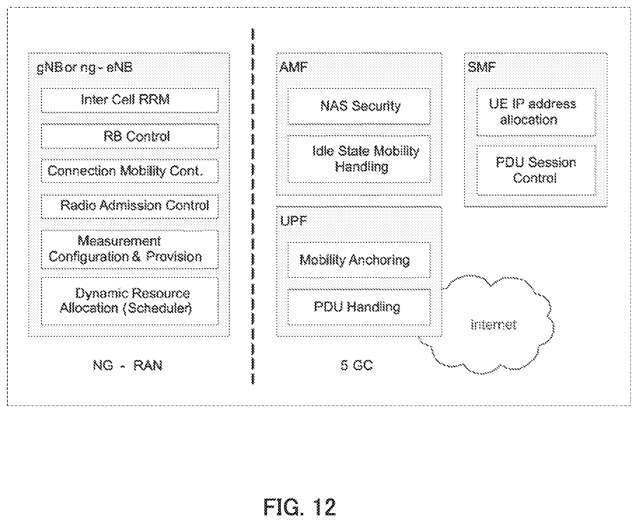

FIG. 12 illustrates functional split between NC-RAN and 5GC. An NG-RAN logical node is a gNB or ng-eNB. The 5GC has logical nodes AMF, UPF, and SMF.

For example, the gNB and ng-eNB host the following main functions:
Functions for radio resource management such as radio bearer control, radio admission control, connection mobility control, dynamic allocation of resources to UEs in both uplink and downlink (scheduling);
IP header compression, encryption, and integrity protection of data;
Selection of an AMF at UE attachment when no routing to an AMF can be determined from the information provided by the UE;
Routing of user plane data towards UPF(s);
Routing of control plane information towards AMF;
Connection setup and release;
Scheduling and transmission of paging messages;
Scheduling and transmission of system broadcast information (originated from the AMF or Operation, Admission, Maintenance (OAM));
Measurement and measurement reporting configuration for mobility and scheduling;
Transport level packet marking in the uplink;
Session management;
Support of network slicing;
QoS Flow management and mapping to data radio bearers;
Support of UEs in RRC_INACTIVE state;
Distribution function for NAS messages;
Radio access network sharing;
Dual Connectivity; and
Tight interworking between NR and E-UTRA.

The access and mobility management function (AMF) hosts the following main functions:
Non-Access Stratum (NAS) signaling termination function;
NAS signaling security;
Access Stratum (AS) security control;
Inter Core Network (CN) node signaling for mobility between 3GPP access networks;
Idle mode UE reachability (including control and execution of paging retransmission);
Registration area management;
Support of intra-system and inter-system mobility;
Access authentication;
Access authorization including check of roaming rights;
Mobility management control (subscription and policies);
Support of network slicing; and
Session Management Function (SMF) selection.

Furthermore, the user plane function (UPF) hosts the following main functions:
Anchor point for intra-/inter-RAT mobility (when applicable);
External protocol data unit (PDU) session point of interconnect to a data network;
Packet routing and forwarding;
Packet inspection and user plane part of policy rule enforcement;
Traffic usage reporting;
Uplink classifier to support routing traffic flows to a data network;
Branching point to support multi-homed PDU session;
QoS handling for user plane (e.g. packet filtering, gating, and UL/DL rate enforcement);
Uplink traffic verification (SDF to QoS flow mapping); and
Downlink packet buffering and downlink data indication triggering.

Finally, the session management function (SMF) hosts the following main functions:
Session management;
UE IP address allocation and management;
Selection and control of UPF;
Configuration function of traffic steering at a user plane function (UPF) to route traffic to proper destination;
Control part of policy enforcement and QoS; and
Downlink data indication.

<RRC Connection Setup and Reconfiguration Procedures>

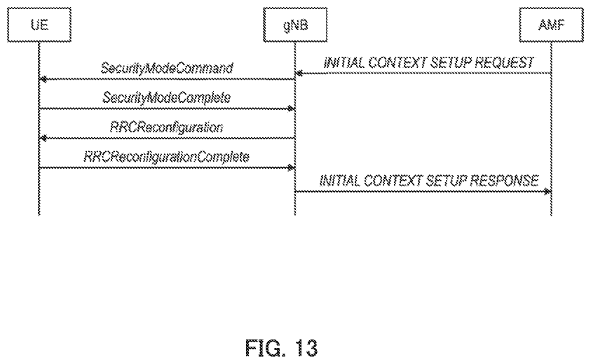

FIG. 13 illustrates some interactions between a UE, gNB, and AMF (an 5GC entity) in the context of a transition of the UE from RRC_IDLE to RRC_CONNECTED for the NAS part (see TS 38.300 v15.6.0).

RRC is a higher layer signaling (protocol) used for UE and gNB configuration. This transition involves that the AMF prepares the UE context data (including, for example, PDU session context, security key, UE radio capability, and UE security capabilities, etc.) and transmits the UE context data to the gNB with an INITIAL CONTEXT SETUP REQUEST. Then, the gNB activates the AS security with the UE, which is performed by the gNB transmitting a SecurityModeCommand message to the UE and by the UE responding to the gNB with a SecurityModeComplete message. Afterwards, the gNB performs the reconfiguration to set up the Signaling Radio Bearer 2 (SRB2) and Data Radio Bearer(s) (DRB(s)) by transmitting an RRCReconfiguration message to the UE and, in response, receiving an RRCReconfigurationComplete from the UE. For a signaling-only connection, the steps relating to the RRCReconfiguration are skipped since the SRB2 and DRBs are not setup. Finally, the gNB indicates to the AMF that the setup procedure is completed with an INITIAL CONTEXT SETUP RESPONSE.

In the present disclosure, thus, an entity (e.g., AMF, SMF, etc.) of the 5th Generation Core (5GC) is provided that includes control circuitry, which, in operation, establishes a Next Generation (NG) connection with a gNodeB, and a transmitter, which in operation, transmits an initial context setup message, via the NG connection, to the gNodeB to cause a signaling radio bearer setup between the gNodeB and user equipment (UE). In particular, the gNodeB transmits a radio resource control (RRC) signaling containing a resource allocation configuration information element (IE) to the UE via the signaling radio bearer. The UE then performs an uplink transmission or a downlink reception based on the resource allocation configuration.

<Usage Scenarios of IMT for 2020 and Beyond>

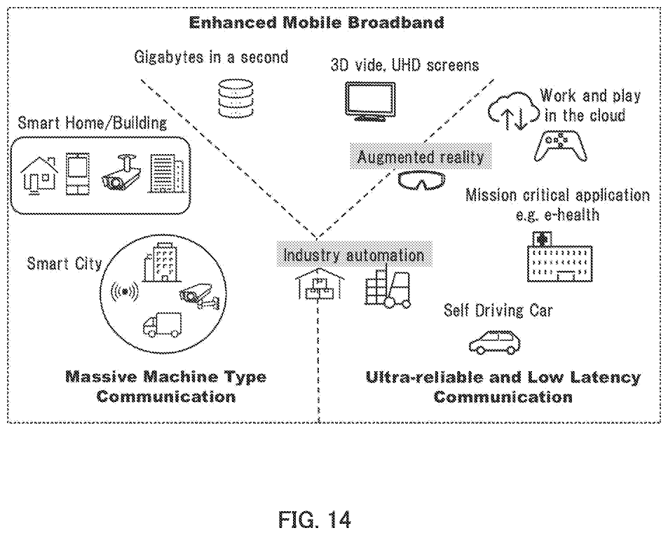

FIG. 14 illustrates some of the use cases for 5G NR. In the 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 14 illustrates some examples of envisioned usage scenarios for IMT for 2020 and beyond (see, for example, ITU-R M. 2083 FIG. 12).

The URLLC use case has stringent requirements for capabilities such as throughput, latency, and availability. The URLLC use case has been envisioned as one of element techniques to enable future vertical applications such as wireless control of industrial manufacturing or production processes, remote medical surgery, distribution automation in a smart grid, transportation safety, etc. Ultra-reliability for the URLLC is to be supported by identifying the techniques to meet the requirements set by TR 38.913. For NR URLLC in Release 15, key requirements include a target user plane latency of 0.5 ms for uplink (UL) and 0.5 ms for downlink (DL). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for the URLLC, more compact DC formats, repetition of PDCCH, etc. However, the scope may widen for achieving ultra-reliability as the NR becomes more stable and developed (for NR URLLC key requirements). Particular use cases of NR URLLC in Release 15 include augmented reality/virtual reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. The pre-emption means that a transmission for which resources have already been allocated is stopped, and the already allocated resources are used for another transmission that has been requested later but has lower latency/higher priority requirements. Accordingly, the already granted transmission is replaced with a later transmission. The pre-emption is applicable independent of the particular service type. For example, a transmission for a service-type A (URLLC) may be replaced with a transmission for a service type B (such as eMBB). Technology enhancements with respect to reliability improvement include dedicated CQI/MCS tables for the target BLER of 1E-5.

The use case of the mMTC (massive machine type communication) is characterized by a very large number of connected devices typically transmitting a relatively low volume of non-delay sensitive data. Devices are required to be low cost and to have a very long battery life. From the NR perspective, utilizing very narrow bandwidth parts is one possible solution to have power saving from the UE perspective and enable the long battery life.

As mentioned above, it is expected that the scope of reliability improvement in NR becomes wider. One key requirement to all the cases, and especially necessary for the URLLC and mMTC for example, is high reliability or ultra-reliability. Several mechanisms can be considered to improve the reliability from the radio perspective and network perspective. In general, there are a few key important areas that can help improve the reliability. These areas include compact control channel information, data/control channel repetition, and diversity with respect to the frequency, time, and/or spatial domain. These areas are applicable to reliability improvement in general, regardless of particular communication scenarios.

For NR URLLC, further use cases with tighter requirements have been considered such as factory automation, transport industry, and electrical power distribution. The tighter requirements are higher reliability (up to 10-6 level), higher availability, packet size of up to 256 bytes, time synchronization down to the order of a few μs where the value can be one or a few μs depending on frequency range and short latency in the order of 0.5 to 1 ms (e.g., target user plane latency of 0.5 ms) depending on the use cases.

Moreover, for NR URLLC, several technology enhancements from the physical layer perspective have been identified. These technology enhancements include Physical Downlink Control Channel (PDCCH) enhancements related to compact DCI, PDCCH repetition, and increased PDCCH monitoring. In addition, Uplink Control Information (UCI) enhancements are related to enhanced Hybrid Automatic Repeat Request (HARQ) and CSI feedback enhancements. Also, PUSCH enhancements related to mini-slot level hopping and retransmission/repetition enhancements have been identified. The term “mini-slot” refers to a transmission time interval (TTI) including a smaller number of symbols than a slot (a slot includes fourteen symbols).

<QoS Control>

The 5G Quality of Service (QoS) model is based on QoS flows and supports both QoS flows that require guaranteed flow bit rate (GBR QoS flows) and QoS flows that do not require guaranteed flow bit rate (non-GBR QoS Flows). At the NAS level, the QoS flow is thus the finest granularity of QoS differentiation in a PDU session. A QoS flow is identified within a PDU session by a QoS flow ID (QFI) carried in an encapsulation header over the NG-U interface.

For each UE, the 5GC establishes one or more PDU sessions. For each UE, the NG-RAN establishes at least one Data Radio Bearer (DRB) together with the PDU session, for example as illustrated above with reference to FIG. 13. Additional DRB(s) for QoS flow(s) of that PDU session can be subsequently configured (it is up to NG-RAN when to do so). The NG-RAN maps packets belonging to different PDU sessions to different DRBs. NAS level packet filters in the UE and 5GC associate UL and DL packets with QoS flows, whereas AS-level mapping rules in the UE and in the NG-RAN associate UL and DL QoS flows with DRBs.

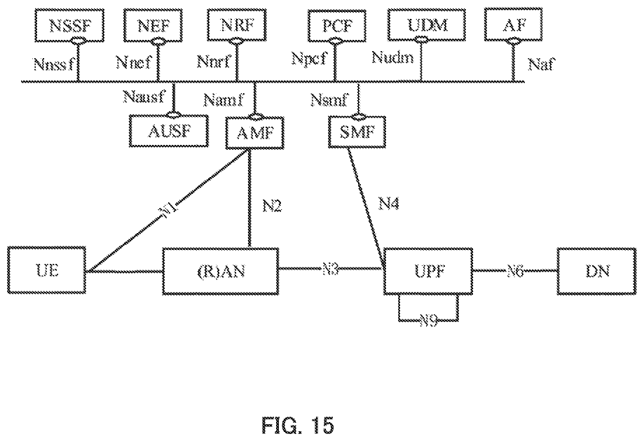

FIG. 15 illustrates a 5G NR non-roaming reference architecture (see TS 23.501 v16.1.0, section 4.23). An Application Function (AF), e.g. an external application server hosting 5G services exemplified in FIG. 14, interacts with the 3GPP core network in order to provide services, for example, to support application influence on traffic routing, accessing a Network Exposure Function (NEF) or interacting with the policy framework for policy control (see Policy Control Function, PCF), e.g. QoS control. Based on operator deployment, application functions considered to be trusted by the operator can be allowed to interact directly with relevant network functions. Application functions not allowed by the operator to access directly the network functions use the external exposure framework via the NEF to interact with relevant network functions.

FIG. 15 illustrates further functional units of the 5G architecture, namely a Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g. operator services, Internet access, or 3rd party services. All of or a part of the core network functions and the application services may be deployed and running on cloud computing environments.

In the present disclosure, thus, an application server (for example, AF of the 5G architecture), is provided that includes a transmitter, which in operation, transmits a request containing a QoS requirement for at least one of the URLLC, eMMB, and mMTC services to at least one of functions (for example NEF, AMF, SMF, PCF, UPF, etc) of the 5GC to establish a PDU session including a radio bearer between a gNodeB and a UE in accordance with the QoS requirement, and control circuitry, which, in operation, performs the services using the established PDU session.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSis as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas. Some non-limiting examples of such a communication apparatus include a phone (e.g. cellular (cell) phone, smart phone), a tablet, a personal computer (PC) (e.g, laptop, desktop, netbook), a camera (e.g. digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A terminal according to an embodiment of the present disclosure includes: control circuitry, which, in operation, determines an available resource candidate by carrier sensing among a plurality of resource candidates that are based on a unit of the carrier sensing; and transmission circuitry, which, in operation, transmits an uplink signal in the available resource candidate.

In an embodiment of the present disclosure, the control circuitry controls transmission of the uplink signal based on a configuration of the plurality of resource candidates.

In an embodiment of the present disclosure, the plurality of resource candidates are linked with a common parameter.

In an embodiment of the present disclosure, the control circuitry determines a size of the uplink signal based on a number of the plurality of resource candidates.

In an embodiment of the present disclosure, the control circuitry uses a transport block generated in any one of the plurality of resource candidates for a transport block for another resource candidate.

In an embodiment of the present disclosure, the control circuitry performs switching of a resource candidate where the carrier sensing is performed among the plurality of resource candidates.

In an embodiment of the present disclosure, the switching of the resource candidate where the carrier sensing is performed includes performing the carrier sensing for a certain resource candidate when a first resource candidate is unavailable as a result of the carrier sensing, the certain resource candidate being referred to as a second resource candidate.

In an embodiment of the present disclosure, the switching of the resource candidate where the carrier sensing is performed is performed every predetermined period.

In an embodiment of the present disclosure, the control circuitry switches an active resource candidate among the plurality of resource candidates in accordance with a certain order.

In an embodiment of the present disclosure, the plurality of resource candidates are shared by a plurality of terminals including the terminal, and the control circuitry selects a resource candidate to be used for transmission of the uplink signal from the plurality of resource candidates in accordance with an order that is different among the plurality of terminals.

A communication method according to an embodiment of the present disclosure includes: determining, by a terminal, an available resource candidate by carrier sensing among a plurality of resource candidates that are based on a unit of the carrier sensing; and transmitting, by the terminal, an uplink signal in the available resource candidate.

The disclosure of Japanese Patent Application No. 2020-077694, filed on Apr. 24, 2019, including the specification, drawings and abstract, is incorporated herein by reference in its entirety.

### INDUSTRIAL APPLICABILITY

An exemplary embodiment of the present disclosure is useful for mobile communication systems.

### REFERENCE SIGNS LIST

100 Base station
101, 201 Receiver
102, 202 Demodulator/decoder
103, 203 Carrier sensor
104 Scheduler
105, 205 Control information holder
106, 206 Data/control information generator
107, 207 Encoder/modulator
108, 208 Transmitter
200 Terminal
204 Transmission controller

1. A terminal, comprising:
control circuitry, which, in operation, determines an available resource candidate by carrier sensing among a plurality of resource candidates that are based on a unit of the carrier sensing; and
transmission circuitry, which, in operation, transmits an uplink signal in the available resource candidate.

2. The terminal according to claim 1, wherein the control circuitry controls transmission of the uplink signal based on a configuration of the plurality of resource candidates.

3. The terminal according to claim 2, wherein the plurality of resource candidates are linked with a common parameter.

4. The terminal according to claim 2, wherein the control circuitry determines a size of the uplink signal based on a number of the plurality of resource candidates.

5. The terminal according to claim 1, wherein the control circuitry uses a transport block generated in any one of the plurality of resource candidates for a transport block for another resource candidate.

6. The terminal according to claim 1, wherein the control circuitry performs switching of a resource candidate where the carrier sensing is performed among the plurality of resource candidates.

7. The terminal according to claim 6, wherein the switching of the resource candidate where the carrier sensing is performed includes performing the carrier sensing for a certain resource candidate when a first resource candidate is unavailable as a result of the carrier sensing, the certain resource candidate being referred to as a second resource candidate.

8. The terminal according to claim 6, wherein the switching of the resource candidate where the carrier sensing is performed is performed every predetermined period.

9. The terminal according to claim 1, wherein the control circuitry switches an active resource candidate among the plurality of resource candidates in accordance with a certain order.

10. The terminal according to claim 1, wherein,
the plurality of resource candidates are shared by a plurality of terminals including the terminal, and
the control circuitry selects a resource candidate to be used for transmission of the uplink signal from the plurality of resource candidates in accordance with an order that is different among the plurality of terminals.

11. A communication method, comprising:
determining, by a terminal, an available resource candidate by carrier sensing among a plurality of resource candidates that are based on a unit of the carrier sensing; and
transmitting, by the terminal, an uplink signal in the available resource candidate.
